(19) United States
(12) Patent Application Publication
(10) Pub. No.: US 2006/0158444 A1
(43) Pub. Date: Jul. 20, 2006

(54) Voltage variation processing mechanism built-in a microcontroller

(75) Inventor: Ching-Huo Huang, Hsinchu City (TW)

Correspondence Address: BIRCH STEWART KOLASCH & BIRCH, PO BOX 747, FALLS CHURCH, VA, 22040-0747, US

(73) Assignee: Sitronix Technology Corp.

(21) Appl. No.: 11/036,034

(22) Filed: Jan. 18, 2005

(51) Int. Cl. G09G 5/00

(52) U.S. Cl. 345/211

(57) ABSTRACT

A voltage variation processing mechanism built-in a microcontroller aims to transmit signals of a low voltage detector or a voltage detector monitor to an address generator, a memory and an instruction register. When the low voltage detector or the voltage detector monitor is activated, the microcontroller is frozen until system voltage is stabilized, then a next program counter starts operation. Therefore system reset frequency may be reduced and system stability is enhanced.

### FIELD OF THE INVENTION

The present invention relates to a voltage variation processing mechanism built-in a microcontroller to manage system voltage fluctuation.

### BACKGROUND OF THE INVENTION

Microcontrollers are built in many forms, such as embedded type, single blade type, RISC type, 8-bit type, 16-bit type, surface mounted type, flat type, and the like. Many selections are available on the market to serve different functions. They are being used in a wide range of applications from consumer appliances to communication products. These days the microcontrollers can perform powerful processing tasks at a very low cost and thus are well accepted in the market place. The microcontroller is especially suitable to perform sequential processing and various non-instantaneous missions. The typical operation speed is about 20 MHz. Some microcontrollers have the nucleus classified according the clock frequency. Each instruction uses multiple numbers of clock cycles. For instance, CISC microcontroller uses maximum 25 simplified instructions for executing a multiply instruction.

There are also a lot of RISC microcontrollers on the market at present. They can execute at a single clock instruction cycle and consume very little power. For instance, The AVR microcontroller of Atmel can achieve the performance of 1 MIP at 1 MHz clock. Armed with such a powerful performance, they can be used in a wide variety of applications. Moreover, these microcontrollers are made in a very compact size. They can be configured from a single ALU equipped with a memory for general I/O to multiple function simulations equipped with bus interfaces.

Instruction process of the microcontroller generally includes: first, fetch an instruction of next step operation or data from a memory (including program read only memory and random access memory), referring to FIG. 1 for the operation procedure of the general microcontroller. The signal is processed by a fetch instruction 11, and sent to a register to perform operation of latch 12. Finally the latched instruction is processed by execution 13. This operation includes decoding and issuing control signals and then returns to the fetch 11 operation to start a next cycle.

In the conventional monitoring system of the microcontroller, accurately resetting the chip is necessary for machine start, stop or abrupt machine down to execute the internal programs of the microcontroller from the beginning. When a great fluctuation of system voltage occurs, the system built with the microcontroller often incurs malfunction due to the unstable voltage.

The most commonly used approach to resolve this problem is shown in FIG. 2. A low voltage detector 24 is included in the system. When the system power supply drops to a lower voltage, an instruction signal is fetched from a memory 21 as previously discussed. The instruction signal is sent to an instructor register 22 to perform latch operation. Then an instruction decoder 23 compiles and executes the instruction signal, and issues a control signal. The system voltage is connected to the low voltage detector 24 which sends a detected signal to a reset circuit 25. A low voltage signal will actuate the reset circuit 25 to send a reset signal to the memory 21, instruction register 22 and instruction decoder 23 to reset elements of the system. The operation flow may be indicated by the following program:

```
if ( low voltage detector active ) then
    reset CPU
else
    Normal operation (fetch → latch → execution ...)
```

For the microcontroller that equips with the low voltage detector 24, the low voltage detector 24 often detects voltage fluctuation and generates reset signals to reset the system. Sometimes the voltage fluctuation is only temporary, and the microcontroller system does not actually at a non-operable low voltage. To prevent the low voltage detector 24 from making mistaken judgement, a common remedial approach is to add some extra circuit elements to handle the mistaken judgement. However, those extra circuit elements make the total circuit more complicated. The circuit reliability also suffers, and fabrication cost is higher.

### SUMMARY OF THE INVENTION

Therefore, the primary objective of the present invention is to alter the internal structure of a microcontroller without adding extra circuit elements to maintain the microcontroller in existing state of affairs when a low voltage detector detects voltage fluctuations thereby to reduce system reset frequency and improve system stability.

Another objective of the present invention is to force the microcontroller to be maintained in a constant condition whether the system voltage variation is directing upwards or downwards, and to continuously execute the follow on programs after the system voltage is stabilized.

The voltage variation processing mechanism for a microcontroller according to the invention aims to send a signal generated by a low voltage detector to an address generator, a memory, and an instruction register that include an instruction decoder are sequentially operated in a microcontroller system. When the low voltage detector is actuated and generates signal, the microcontroller is frozen until the system low voltage condition ends and the voltage is stabilized, and then proceeds to the operation according to the next program counter.

Moreover, the low voltage detector may also be replaced by a voltage detector monitor. When the system voltage alters downwards or upwards, the voltage detector monitor is actuated to freeze the microcontroller until the low voltage condition ends and the voltage is stabilized, then proceeds operation according the next program counter.

Therefore, the microcontroller according to the invention may be constructed simply without an extra design. And system reset frequency may be reduced, and system stability improves.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an operation flow of a conventional microcontroller.

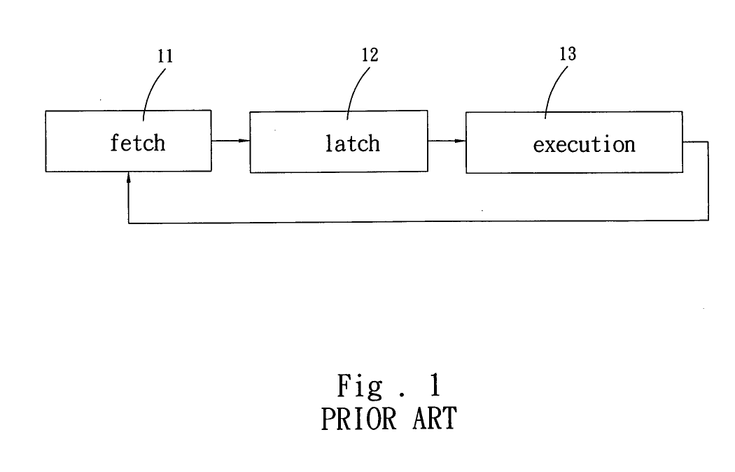

FIG. 2 is a schematic view of a low voltage processing mechanism of a conventional microcontroller.

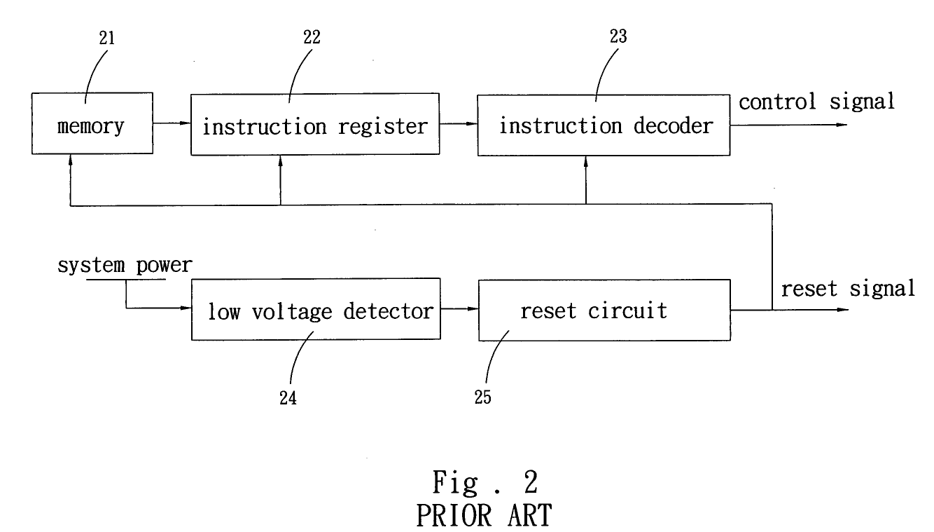

FIG. 3 is a schematic view of the low voltage processing mechanism of the invention.

FIG. 4 is a schematic view of another voltage variation processing mechanism of the invention.

### DETAILED DESCRIPTION OF THE PREFERRED EMBODIMENTS

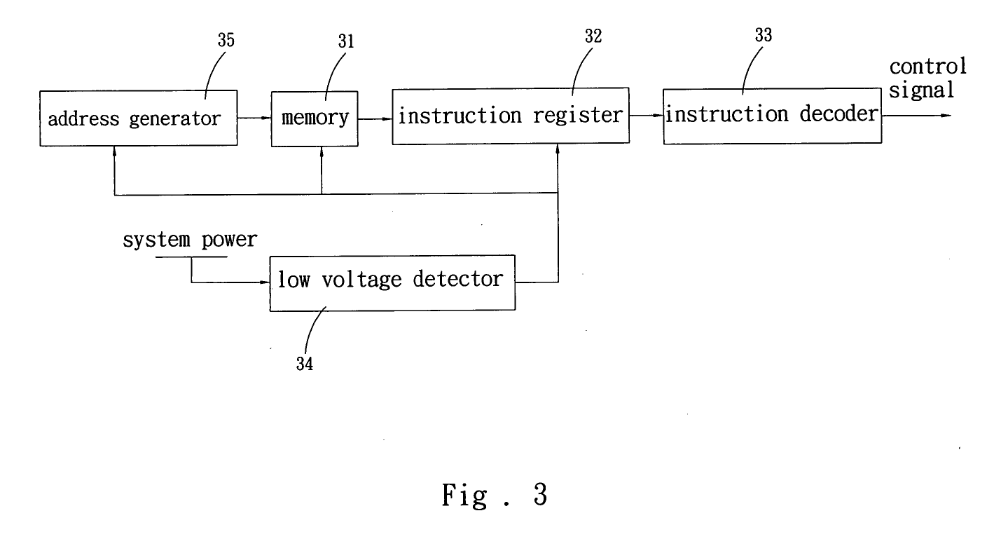

Please refer to FIG. 3 for a low voltage processing mechanism provided by a microcontroller according to the present invention. The voltage variation processing mechanism built-in a microcontroller of the invention aims to control an address generator 35, a memory 31, an instruction register 32 and an instruction decoder 33 that sequentially operate in a microcontroller system and function like in a conventional microcontroller. First, an instruction signal is fetched from the memory 31 and sent to the instruction register 32 for latch operation. Then the instruction signal is sent to the instruction decoder 33 to be compiled and executed to issue a control signal. System voltage is connected to a low voltage detector 34 which sends a signal to the address generator 35, memory 31 and instruction register 32. When the low voltage detector 34 is operating, the microcontroller is in frozen state, namely the address generator 35 maintains its original value to disable the next program counter (PC+1). Meanwhile the content of the instruction register 32 is “NOP” (the instruction NOP means to skip to the next line without doing anything) and all access operations of the memory 31 are stopped without resetting the system as the conventional technique does. The frozen state of the microcontroller is maintained until the low voltage condition is over and the voltage is stabilized again. Then the operation of the next program counter resumes. The operation flow can be indicated by the program as follow:

```
if (low voltage detector active ) then
  wait (synchronize)
  freeze CPU status
        ( PC = PC, IR = NOP, etc)
  until (low voltage detector disable)
else
    Normal operation
```

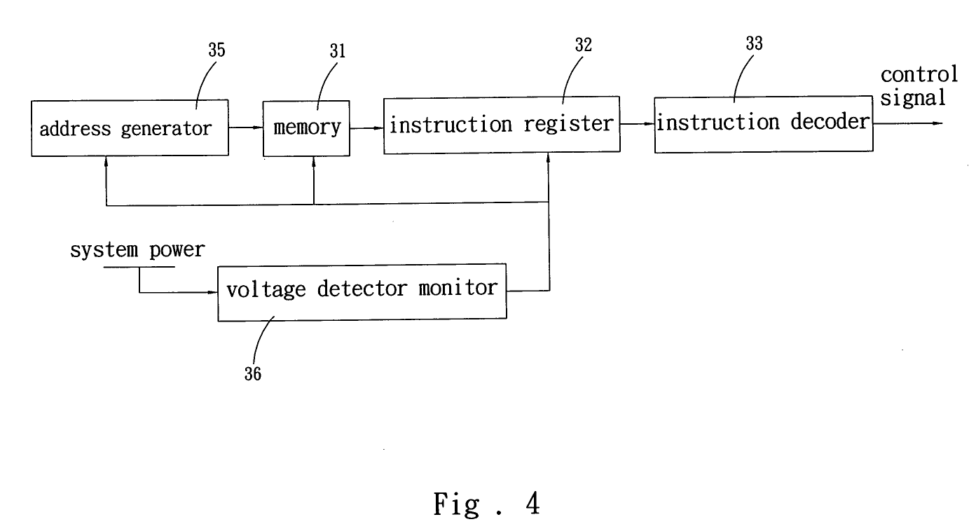

The low voltage detector 34 may be replaced by a voltage detector monitor 36 as shown in FIG. 4. In this embodiment, the signal of the voltage detector monitor 36 is sent to the address counter 35, memory 31 and instruction register 32. When there is a system voltage variation which includes going downwards or upwards and exceeding the allowable range of the system, the voltage detector monitor 36 starts operation to freeze the microcontroller. And the address generator 35 maintains its original value to disable the next program counter (PC+1). Meanwhile the content of the instruction register 32 is “NOP” (the instruction NOP means to skip to the next line without doing anything) and all access operations of the memory 31 are stopped. The frozen state of the microcontroller is maintained until the voltage variation condition is over and the voltage is stabilized again. Then the operation of the next program counter resumes. The operation flow can be indicated by the program as follow:

```
if (huge voltage variation ) then
  wait (synchronize)
  freeze CPU status
        ( PC = PC, IR = NOP, etc)
  until (voltage variation monitor disable)
else
    Normal operation
```

Thus the voltage variation processing mechanism built-in a microcontroller according to the invention can provide the desired functions by altering the internal structure without adding extra circuit elements. When the low voltage detector 34 detects voltage fluctuation, it freezes the microcontroller to maintain the existing condition so that system reset frequency may be reduced and system stability is enhanced.

The low voltage detector 34 may be replaced by a voltage detector monitor 36 to trigger and force the microcontroller to maintain the existing condition either the system voltage variation is directing upwards or downwards until the system voltage is stabilized and then the follow on programs are executed.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A voltage variation processing mechanism built-in a microcontroller to operate an address generator, a memory, an instruction register and an instruction decoder that operate sequentially in a microcontroller system, comprising a low voltage detector which is connected to the address generator, the memory and the instruction register to transmit signals so that when the low voltage detector is activated the microcontroller is frozen, and the instruction register contains a value of “NOP”, and the address generator maintains an original value and the memory stops data access until a system low voltage condition is over and the voltage is stabilized to resume a next program counter operation.

2. A voltage variation processing mechanism built-in a microcontroller to operate an address generator, a memory, an instruction register and an instruction decoder that operate sequentially in a microcontroller system, comprising a voltage detector monitor which is connected to the address generator, the memory and the instruction register to transmit signals so that when the system voltage has variations and the voltage detector monitor is activated the microcontroller is frozen, and the instruction register contains a value of “NOP”, and the address generator maintains an original value and the memory stops data access until the system voltage variation ends and the voltage is stabilized to resume a next program counter operation.

3. The voltage variation processing mechanism of claim 2, wherein the voltage variation of the system can alters upwards and downwards.
